(19) United States
(12) Patent Application Publication
(10) Pub. No.: US 2002/0107002 A1
(43) Pub. Date: Aug. 8, 2002

(54) Personalised alerting and response system and method

(76) Inventors: David Duncan, Edinburgh (GB); Ronald Forbes, Edinburgh (GB)

Correspondence Address: SALTAMAR INNOVATIONS, 30 FERN LANE, SOUTH PORTLAND, ME, 04106, US

(21) Appl. No.: 09/681,173

(22) Filed: Feb. 8, 2001

(51) Int. Cl. H04M 11/10

(52) U.S. Cl. 455/412; 455/466; 455/566

(57) ABSTRACT

System for sending text message alerts to users 35 of mobile communications devices 30. Text message 45 contains only summary information and a user can access further information by downloading a personalized response web page 110 which contains links directly to relevant further information. Response web page 110 may be provided by HTML, WAP, iMODE or related technologies. Links followed may be monitored to provide marketing leads. Particularly useful for messages relating to vacancies or properties for sale.

### BACKGROUND OF THE INVENTION

The present invention relates to a system and method for sending personalised alerts to users via their mobile phone and providing them with means to respond to such alerts.

Markets such as employment, recruitment, property and motor vehicles sales are time-critical, in that being able to respond to offers in a short space of time increases the individual's chance of achieving their desired end (e.g.—getting a particular job or buying a specific house or car at a specific price). Similarly, products or services with a limited availability are time-critical.

In such markets, it would therefore provide an advantage to individuals if they were to receive an automatic and almost instant SMS (Short Message Service) text message alert via their mobile phone which provides them with the ability to access further details on products, services or information in which they have a previously specified and registered interest i.e.—the alerts and subsequent information is personalised. It would be a further advantage if a particular individual could then respond to the further detail, e.g. by submitting an offer to purchase property, or submitting a job application. This is particularly important as short messages allow only a limited quantity of text, whereas one might wish to provide a considerable amount of further information which could not be sent in a cost-effective manner nor welcomed by the recipient.

This system provides benefits to information providers since they can carry out targeted and permission-based marketing, that is to say sending information only to those individuals who have previously shown an interest in a particular product, service or piece of information which the information provider is equipped to provide.

In the prior art, methods and systems are known which utilise SMS text messages/alerts to disseminate information to individual mobile phone users.

International Patent Application No 97/41654 provides for the sending of information which is updated at regular intervals in accordance with a profile defined by the mobile phone user. The messages are transmitted at pre-determined times or upon the occurrence of a pre-determined event. The user can also request information at their discretion.

European Patent Application No 1008946 provides for a mobile device which is equipped with a global positioning system and can be programmed to alert the user when he or she arrives at a pre-determined destination or within a specified range of the destination. Information associated with the location can also be disseminated in response to a user-programmed request.

International Patent Application No 98/16412 discloses the use of SMS text messages as car alarms. Upon physical damage being inflicted on a car, a pre-programmed message is transmitted to a central messaging server, which then transmits an alarm message to the owner's mobile phone.

International Patent Application No 99/65256 provides for the delivery of e-mail notifications to digital mobile phones (including information on the e-mail such as who sent it and at what time, for example.) Delivery of the e-mail itself in summarized form is also provided for.

It is an object of the present invention to provide a system which allows personalised alerts to be automatically sent to mobile phone users, and allows users to subsequently respond by accessing further personalised information.

It is a further object of the present invention to provide a method by which information providers can gain access to information on potential markets through individuals registering an interest in receiving alerts which are specifically related to the information provider” specific area of operation.

### SUMMARY OF INVENTION

According to a first aspect of the present invention there is provided a messaging system comprising: a response server constructed to cooperate with a messaging service adapted for sending messages to mobile communication devices associated with users; said messages are selected to be associated with further information meeting criteria particular to a user; wherein said messages comprise summary information associated with further information; and, wherein said response server is adapted to provide a response web page having at least one link therein; said link points to said further information associated with a message sent to a user.

Preferably, the user is identifiable by the response server and the response web page is personalized.

Typically, the message comprises the web address of the response web page.

Preferably, the message is a text message.

More preferably, the message is a SMS text message.

The response server may be a WAP gateway.

The messaging system may be adapted to monitor which links to further information are followed by a user.

Preferably, the messaging system is adapted to receive summary information from an external information provider.

More preferably, summary information is received already matched to particular users.

The messaging system may further comprising a matching engine adapted to select messages associated with summary information or further information meeting criteria relating to a user.

Preferably, said messaging service comprises a messaging server adapted to initiate sending of said messages.

Said messaging server may be integral with said response server.

Said response server may be performed by a computer linked to said messaging server via a data network.

According to a second aspect of the present invention there is provided a method of providing information to users having mobile communications devices, the method comprising the steps of: obtaining summary information matched to at least one user according to criteria; sending a message to a mobile communication device associated with said user, said message comprising said summary information; and providing a response web page comprising at least one link to further information associated with said message.

Preferably, the method further comprises the step of receiving summary information from an external information provider.

More preferably, said summary information is received already matched to particular users.

Said summary information may be matched to particular users by a matching engine.

Typically, said criteria are specified by a user.

The method may further comprise the steps of identifying the user and personalising the link page.

The message may further comprise the web address of the response web address.

Preferably, the message is a text message.

More preferably, the message is a SMS text message.

Said message may be a voice message.

Said summary information may comprise text, and the method may further comprise the step of converting said text into speech for delivery as a voice message.

The web server may be a WAP server.

The method may further comprise the step of monitoring which links are followed by a particular user.

According to a third aspect of the present invention there is provided a method of providing marketing leads comprising the steps of: providing information to users having mobile communications devices by: matching information to users according to criteria; sending a message to a user's mobile communication device, said message comprising summary information; providing a web page comprising at least one link to further information associated with each message supplied to a user; and, monitoring which links are followed by a user.

The method may further comprise the step of sending an email to the supplier or the information provider.

According to a fourth aspect of the present invention there is provided computer software which, when loaded onto a computer, enables it to perform as the messaging system of the first aspect.

According to a fifth aspect of the present invention there is provided computer software comprising a web page being the link page of the first aspect.

According to a sixth aspect of the present invention there is provided a messaging system comprising: a messaging server adapted to initiate sending messages to mobile communication devices associated with users; said messages comprise summary information associated with further information, and are selected to be associated with further information meeting criteria particular to a user; and, a response server comprising a response web page having at least one link therein, which points to said further information associated with a message sent to a user.

Preferably, the user is identifiable by the response server and the response web page is personalized.

The message may also comprise the web address of the response web page.

Preferably, the message is a text message.

More preferably, the message is a SMS text message.

The response server may be a WAP gateway.

The messaging system may be adapted to monitor which links to further information are followed by a user.

The messaging system may be adapted to receive summary information from an external information provider.

Preferably, summary information is received already matched to particular users.

The messaging system may further comprise a matching engine adapted to select messages associated with summary information or further information meeting criteria relating to a user.

### BRIEF DESCRIPTION OF THE DRAWINGS

In order to provide a better understanding of the present invention an example will now be described by way of example only, and with reference to the accompanying Figures, in which:

FIG. 1 illustrates the interaction between information providers, the server and the user's mobile communication device;

FIG. 2 illustrates the detail of the physical architecture of the system;

FIG. 3 illustrates an example of a text message sent to a user; and

FIG. 4 shows a links page personalised to a user.

### DETAILED DESCRIPTION

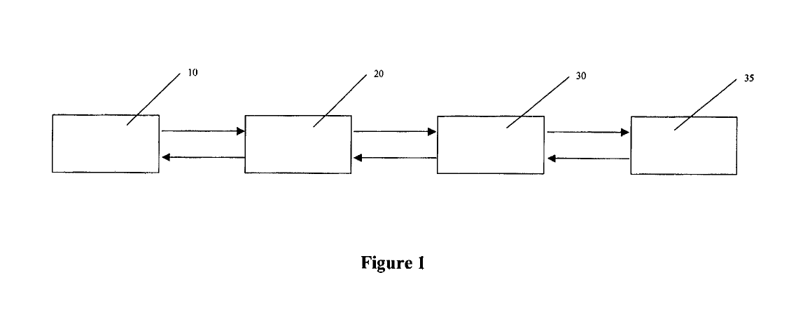

Referring firstly to FIG. 1, information provider 10 supplies server 20 with summarised information for selective transmission to users 35 of mobile communication devices 30. Information may pertain to products or services or any other items of interest, such as news stories. A function of the system as a whole is to provide information to individual users 35 which meets a user's predefined criteria.

For example, users might require information about houses for sales, selected to be in a particular price range, have a particular number of rooms, be in a particular location etc. In another example, users might wish information concerning job opportunities or a specified type in a particular location, with a particular salary. Typically, a user will initially be sent summary information only.

In the preferred embodiment, information is transmitted to the server 20 already matched to a particular user or users 35. However, in an alternative embodiment, information is transmitted to the server 2O in an unmatched form and the server 20 selectively matches particular information with particular users 35 as described below according to a user's pre-defined criteria.

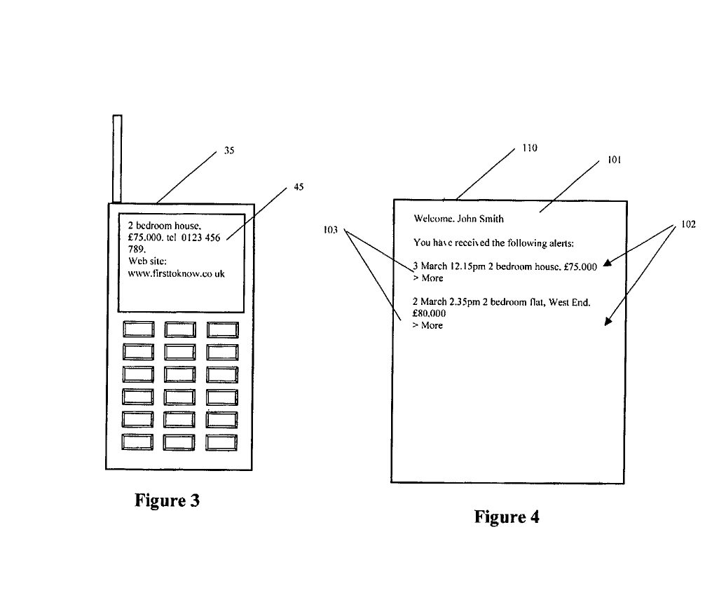

The server 20 sends an alert message 45 to the user's mobile communications device 30 notifying them of the information of pre-stated interest to them and sending them summary information. With reference to FIG. 3, the alert message 45 is preferably a text message; alternatively it might be a voice message, video message or mixed-media message. In the preferred embodiment it is a GSM Short Text Message (SMS). Another embodiment uses WAP PUSH technology. Another embodiment uses iMode.

In general, various forms of wireless text messaging may be used. Wireless text messaging is the provision over a telecommunications network to a wireless mobile communications device of a message comprising text. It therefore involves substantially less data being transferred than in a live voice call and various text messaging formats can be selected and used with different telecommunications systems. Additional examples include cell phone text messaging and pager text messaging.

The user 35 can respond to the alert message and access further information on the relevant product, service, opportunity, etc. This may be achieved by providing the user with a telephone number which accesses the desired information in pre-recorded form or by talking to a consultant. Preferably, however, further information is provided via a response web site operably connected to the messaging server 20 which contains further information, or provides links or bookmarks to further information on the information provider” web site.

In the preferred embodiment, the response web site is a WAP portal which also provides links to the further information. The response web site may comprise one or more servers adapted to serve wireless and other portable mobile devices as well as provide HTML web pages. In a preferred embodiment, an HTML web server and a server supporting the WAP communications protocol are separate devices. The alert messages may include the address of the response web site, as a link or otherwise.

The response web site comprises web pages 110 including links to further information related to the summary information provided in each message and is described further below. Importantly, the page is personalised to each user or a group of users, and the links are directed to relevant further information directly, rather than simply linking to home pages belonging to individual firms.

Mobile communications devices 30 are typically mobile telephones, such as GSM, GPRS or future mobile telecommunications formats. The messaging server 20 is typically a web server which communicates with the information provider 10 by HTTP, although alternative communications means may be selected by one skilled in the art. The messaging server functionality can be readily implemented by one skilled in the art in an industry standard development environment and the HTTP servers can be implemented with, for example, APACHE™, or other similar servers. A Java™ application web server may be developed using e.g. TOMCAT™ or iPLANET™.

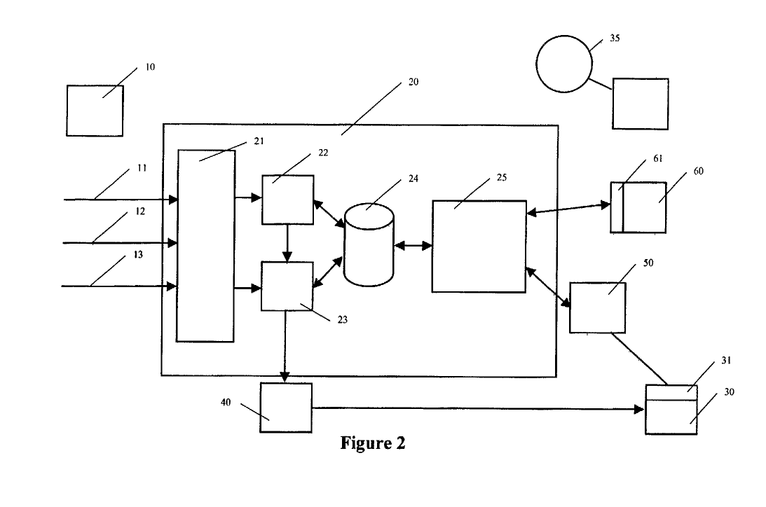

With reference to FIG. 2, information provider 10 sends information feeds in one of a variety of formats, usually over the internet. These feeds 11, 12, 13 are processed by a feed processor 21 which preferably incorporates an HTTP server.

In the preferred embodiment, an information feed 12, 13 is supplied prematched to individual users 35. This can be accomplished in XML 12 or as a “flat file” structure 13. In this case a matching engine is preferably maintained by the information provider.

In alternative embodiments, information 11 is sent to the server feed processor 21 without having been previously matched to particular users 35 and in XML format, which can readily be adapted to any internal format by means standard in the art. Information is sent separately or together relating to a user's criteria. A matching engine 22 then establishes which user's criteria fits the information, for example by comparing properties of the information in turn against a list of user criteria by standard database query techniques, and selecting the user or users that are to receive the associated message.

The system also requires user information such as names 101, mobile telephone numbers, preferences etc. This information can be either stored separately in the server 20 or supplied along with prematched information 12, 13 by the information provider 20. Users may register their details and criteria on the relevant information provider sign-up web site, on the system's server 20, or by any other convenient means. The user also authorises the information provider to send them SMS text messages relevant to their chosen criteria via the system's server.

In an embodiment where information is not provided prematched, the server 20 maintains a database 24 of the Information Feeds received from information providers. When product/service information within database 24 matches registered user criteria, Matching Engine 22 detects this and generates SMS text message alerts as appropriate. These alerts are then sent to the user 35 via messaging server 23, typically a server adapted to send SMS messages to the user's mobile communication device 30 through communication with Short Message Service Centre 40. Messages may alternatively be in the form of e-mail with summary information sent, for example, as a simple or text only e-mail.

The user 35 can then respond to an alert by several means. They might respond by telephone using a telephone number provided within the body of the text message, but will preferably access a web browser 61 on e.g. a personal computer 60 or will use a mobile browser such as a WAP browser 31 on their mobile communication device 30. The system further comprises a response server 25 which can communicate with a web browser 61 in HTML, a WAP browser 31 in WML or can be adapted to cooperate with other networking protocols.

With reference to FIG. 4, an important feature is that each user 35 is thereby presented with a personalised response web page 110. The user 35 may access this personalised response web page 110 by signing in through the internet using their mobile phone number and a secret personal identification password. Instead of signing in each time, it is preferred that the user be immediately recognised by use of automatic password entry, cookies, caller line identification or other known identification system.

The response web page 110 is prepared on request by the response server 25 in accordance with information stored in the central database 24 and personalised to the particular user . The web page 110 may show a user identifier 101 and contains summaries or copies 102 of the alert messages that have been recently sent to the particular user. Summaries or copies 102 have one or more links 103 associated therewith, the links pointing to further information. The links may be directed to web sites belonging to the information provider 10 or third party web sites. In particular, the links may point to specific pages relating to the specific information, e.g. a page dealing with a specific house or job and not just to introductory pages e.g. the home page of an estate agents or recruitment consultants.

Additional exchanges of information may take place after the user has accessed the further information, such as a purchase transaction or the submission of a job application or offer to buy property.

In response to a user selecting a link from a personalised response web page 110, the messaging server notifies information providers that a user has accessed the further information by following the link, and thus become a potential buyer, employee, bidder, etc. This allows the information provider to be proactive in making contact with the user who has a pre-stated interest in their goods or services and can readily be accomplished by techniques known in the field of online advertising.

Another advantage of the present invention is that there is provided a means for mobile phone users to receive personalised alerts, but unlike the prior art in the area of SMS text message alerting, the system also provides them with means to respond to the alert and access further information through a personalised response web page 110.

By sending summary information only as short alerts, users 35 can be kept informed of relevant information, while minimizing the cost of sending a large amount of further information immediately to the user 35.

Further advantages of the system are provided to system users by saving time that would otherwise be spent hunting for a product, service or for information which is of particular interest to them, by being automatically alerted to the availability of such items and information. Users are then able to quickly and easily respond to the alert by accessing relevant further information. This more detailed information facilitates the making of a timely and convenient informed decision by the user, regardless of time or location.

The system is highly focused and targeted, as a user is only notified of products/services which match his/her own particular pre-defined requirements. This targeting provides the user with an incentive to visit information provider” web sites and use their services or buy their products.

The system provides further advantages to information providers as it allows their agents to focus their time on potential markets and individual consumers who have a previously stated interest in the offered product, service or information.

Further modification and improvements may be added without departing from the scope of the invention herein intended.

1. A messaging system comprising:
a response server constructed to cooperate with a messaging service adapted for sending messages to mobile communication devices associated with users; said messages are selected to be associated with further information meeting criteria particular to a user;
wherein said messages comprise summary information associated with further information; and,
wherein said response server is adapted to provide a response web page having at least one link therein; said link points to said further information associated with a message sent to a user.

2. The messaging system of claim 1 wherein the user is identifiable by the response server and the response web page is personalized.

3. The messaging system of claim 1 wherein the message comprises the web address of the response web page.

4. The messaging server of claim 1 wherein the message is a text message.

5. The messaging system of claim 4 wherein the message is a SMS text message.

6. The messaging system of claim 1 wherein the response server is a WAP gateway.

7. The messaging system of claim 1 adapted to monitor which links to further information are followed by a user.

8. The messaging system of claim 1 adapted to receive summary information from an external information provider.

9. The messaging system of claim 8 wherein summary information is received already matched to particular users.

10. The messaging system of claim 1 further comprising a matching engine adapted to select messages associated with summary information or further information meeting criteria relating to a user.

11. The messaging system of claim 1 wherein said messaging service comprises a messaging server adapted to initiate sending of said messages.

12. The messaging system of claim 11 wherein said messaging server is integral with said response server.

13. The messaging system of claim 11 wherein said response server is performed by a computer linked to said messaging server via a data network.

14. A method of providing information to users having mobile communications devices, the method comprising the steps of:
obtaining summary information matched to at least one user according to criteria;
sending a message to a mobile communication device associated with said user, said message comprising said summary information; and,
providing a response web page comprising at least one link to further information associated with said message.

15. The method of claim 14 comprising the step of receiving summary information from an external information provider.

16. The method of claim 15 wherein said summary information is received already matched to particular users.

17. The method of claim 14 wherein said summary information is matched to particular users by a matching engine.

18. The method of claim 14 wherein said criteria are specified by a user.

19. The method of claim 14 wherein the user is identified and the link page is personalized.

20. The method of claim 14 wherein the message comprises the web address of the response web address.

21. The method of claim 14 wherein the message is a text message.

22. The method of claim 21 wherein the message is a SMS text message.

23. The method of claim 14 wherein said message is a voice message.

24. The method of claim 23 wherein said summary information comprises text, and wherein the method further comprises the step of converting said text into speech for delivery as a voice message.

25. The method of claim 14 wherein the web server is a WAP server.

26. The method of claim 14 further comprising the step of monitoring which links are followed by a particular user.

27. A method of providing marketing leads comprising the steps of:
providing information to users having mobile communications devices by:
matching information to users according to criteria;
sending a message to a user's mobile communication device, said message comprising summary information;
providing a web page comprising at least one link to further information associated with each message supplied to a user; and,
monitoring which links are followed by a user.

28. The method of claim 27 further comprising the step of sending an email to the supplier or the information provider.

29. Computer software which when loaded onto a computer enables it to perform as the messaging system of claim 1.

30. Computer software comprising a web page being the link page of claim 1.

31. A messaging system comprising:
a messaging server adapted to initiate sending messages to mobile communication devices associated with users;
said messages comprise summary information associated with further information, and are selected to be associated with further information meeting criteria particular to a user; and,
a response server comprising a response web page having at least one link therein, which points to said further information associated with a message sent to a user.

32. The messaging system of claim 31 wherein the user is identifiable by the response server and the response web page is personalized.

33. The messaging system of claim 31 wherein the message comprises the web address of the response web page.

34. The messaging server of claim 31 wherein the message is a text message.

35. The messaging system of claim 34 wherein the message is a SMS text message.

36. The messaging system of claim 31 wherein the response server is a WAP gateway.

37. The messaging system of claim 31 adapted to monitor which links to further information are followed by a user.

38. The messaging system of claim 31 adapted to receive summary information from an external information provider.

39. The messaging system of claim 38 wherein summary information is received already matched to particular users.

40. The messaging system of claim 31 further comprising a matching engine adapted to select messages associated with summary information or further information meeting criteria relating to a user.
